(19) United States
(12) Patent Application Publication
(10) Pub. No.: US 2006/0098864 A1
(43) Pub. Date: May 11, 2006

(54) Method and apparatus to display 3d rendered ultrasound data on an ultrasound cart in stereovision

(76) Inventor: Jonathan Mark Ziel, North Andover, MA (US)

Correspondence Address: PHILIPS INTELLECTUAL PROPERTY & STANDARDS, P.O. BOX 3001, BRIARCLIFF MANOR, NY, 10510, US

(21) Appl. No.: 10/536,643

(22) PCT Filed: Nov. 13, 2003
(86) PCT No.: PCT/IB03/05438

§ 371 Date: May 27, 2005

Related U.S. Application Data
(60) Provisional application No. 60/430,396, filed on Dec. 3, 2002.

(51) Int. Cl. G06K 9/00

(52) U.S. Cl. 382/154; 382/128

(57) ABSTRACT

An ultrasound apparatus and method including an emitter to emit ultrasound signals, a receiver to receive reflected ultrasound signals, and a display unit to display a stereovision ultrasound image in real time from the reflected ultrasound signals. The apparatus also includes a generator to generate 3D ultrasound data volumes from the reflected ultrasound signals and a rendering processor to render the 3D ultrasound data volumes into first and second 2D images by streaming. A transport unit such as a cart houses the emitter, the receiver, the display unit, the rendering processor and the generator.

The present invention relates to a portable ultrasound device that is housed on an ultrasound cart, and more particularly, to an ultrasound device that produces a real time stereovision image while still on the ultrasound cart.

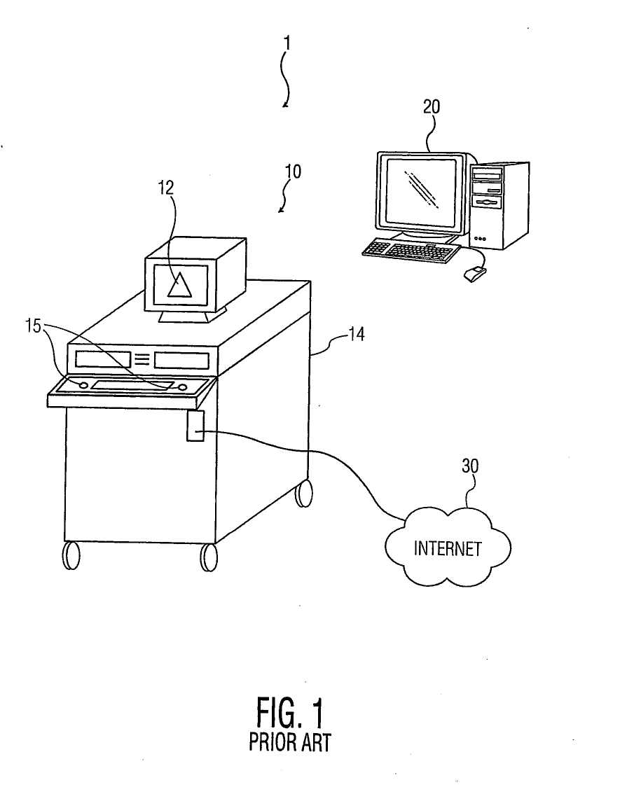

Ultrasound generally operates by transmitting ultrasound signals into the body, and then receiving the echoes of the ultrasound signals off of internal objects to generate an image. These internal objects may be a fetus or internal organs such as a heart or kidney. FIG. 1 is a diagram illustrating a conventional system 1 of generating the ultrasound image. An ultrasound machine 10 is small enough to fit on a cart 14, thereby allowing the ultrasound machine 10 to be transported to bed-ridden patients or from one operating room to another. The ultrasound machine 10 emits and receives the ultrasound signals and generates a volume of data from the received ultrasound signals. This data is used to generate the ultrasound image on a screen 12 of the ultrasound machine 10, or may be downloaded onto a disc (not shown) which is physically carried to an off-line workstation 20, or exported electronically over a network 30 and stored at an external location such as an internet or intranet website or a network storage server, where the data can be accessed by a workstation to generate and analyze images.

A disadvantage of the conventional system 1 is that it cannot generate a stereovision image in real time while on the cart 14. “Real time” means that it appears from the point of view of a user that the image generated on the screen 12 represents the actual condition of a patient at a particular instant in time, even though it may take a very small but finite amount of time for the system to process the information and display the same. Thus, as far as the user can detect, the ultrasound image is contemporaneously displaying the object being analyzed. “Real Time” can be achieved with a frame update rate greater than or equal to 5 Hz (frames per second) and a latency from the start of dataset acquisition to display of less than or equal to 0.5 seconds.

A stereovision image has true depth, as opposed to two-dimensional (2D) images that try to achieve a three-dimensional (3D) effect by shading or other methods of providing depth dependent visual cues such as 1) Perspective Projection which makes objects farther away from the viewer look smaller, for example, railroad tracks appear to converge in the distance; 2) Depth Dependent Shading which makes objects farther away from the viewer look darker, 3) Lighting which indicates depth with shadows. The stereovision effect is achieved by reproducing an image from two slightly different angles, for example, a left eye angle and a right eye angle, and alternately displaying the left and right images, thereby fooling the brain into seeing an image with true depth. Thus, the user feels as if he can put his hand behind the image or even inside it.

Images generated on the cart 14 have previously been limited to images requiring only small amounts of data. For example, the conventional system 1 can generate a 2D image in real time on the cart 14, if there is no 3D effect. The conventional system 1 can generate a 2D image with a 3D effect on the cart 14, but this is not a stereovision image, and this image is not in real time. Instead, there is a delay between acquiring the image data and generating the image. Historically, it has taken 3-5 minutes to acquire the data, and then upwards of 10-20 minutes before the image is displayed. Often, the image is rotated slightly, typically between 5 and 20 degrees, back and forth, in order to achieve a perception of depth.

This system is disadvantageous because it does not display an image having true depth. Furthermore, due to the delay between acquiring the data and generating the image, it is extremely time consuming to achieve an acceptable image. Typically, the initial image is not satisfactory, and the sonographer (such as a doctor or technician) must adjust scanning parameters such as gain and angle of insonation with image controls 15. Color doppler imaging mode requires additional user controls that are interdependent and must be optimized together such as wall filter settings, scale settings, threshold, etc. Furthermore, the sonographer may want to view an entirely different portion of the object. Each time an adjustment is made, the user must wait up to 20 minutes to see whether the adjustment achieved the desired result, instead of receiving immediate feedback. Multiple adjustments are often required, resulting in a significant waiting period before a useful image is achieved.

Another disadvantage is that the resulting image jumps around, as opposed to being smooth and lifelike. This is particularly disadvantageous when viewing a continuously moving body, such as a beating heart Thus, although vendors of these previous designs may market their images as “real time,” this depiction is erroneous, insofar as there is a significant delay between adjusting the parameters/acquiring the data and displaying the image.

Using previous designs, if the desired image requires large amounts of data, then the image must be generated off of the cart 14. This limitation is due to the fact that the data rendering processing of the conventional ultrasound machine 10 is too slow. The conventional ultrasound machine 10 collects 3D data from the reflected ultrasound signals, and this data must be rendered into a 2D representation. The conventional ultrasound machine 10 cannot render the data “on-the-fly” by streaming the data, but instead rendering is accomplished in “batch” mode after the acquisition is complete. Streaming indicates that the acquisition does not stop when the rendering starts: as one dataset is being rendered the next dataset is being acquired. Batch mode means that first, the entire data set is acquired. Then, it is saved as a file. Then a rendering program opens that file and renders the data. Often, “batch” processing includes writing the file to a compact disc (CD) or sending the data over a network to a storage server. The data is then analyzed with an off-line workstation 20.

Stereovision is an example of an image type that previously required off-cart analysis. Since stereovision requires left and right angle views of each dataset, twice as much processing must occur on each dataset. Stereovision also requires a rapidly alternating display of the left and right views. To successfully achieve the 3D effect, the two images must be displayed alternately at 120 Hz. That is, the left angle image must be displayed at 60 Hz interleaved with the right angle image at 60 Hz. However, in previous designs, a maximum of only 30 image frames per second could be displayed on the cart, which is too slow to achieve the stereovision effect. This limitation of the conventional system 1 is not limited to stereovision images, but applies to other 3D representations as well.

Generating the image off of the cart 14 is disadvantageous because it is time consuming. Furthermore, if the ultrasound procedure was not performed properly, this fact would not be discovered until a later time. Thus, the patient would have to have the ultrasound device applied a second time, either after waiting for the off-line results, or by coming back at a later date.

The present invention relates to an ultrasound apparatus comprising an emitter to emit ultrasound signals, a receiver to receive reflected ultrasound signals, and a display unit to display a stereovision ultrasound image in real time from the reflected ultrasound signals. The apparatus also includes an acquisition subsystem to acquire the 3D ultrasound volume data from the reflected ultrasound signals, and a rendering processor to render the 3D ultrasound data volumes into left and right angle 2D images in streaming mode. A generator to generate 3D ultrasound data volumes from the reflected ultrasound signals and a rendering processor to render the 3D ultrasound data volumes into first and second 2D images by streaming may also be included. A transport unit such as a cart houses said emitter, receiver, display unit, acquisition subsystem, and rendering processor.

These and other objects and advantages of the invention will become apparent and more readily appreciated from the following description of the preferred embodiments, taken in conjunction with the accompanying drawings of which:

FIG. 1 is a diagram illustrating a conventional system of generating an ultrasound image;

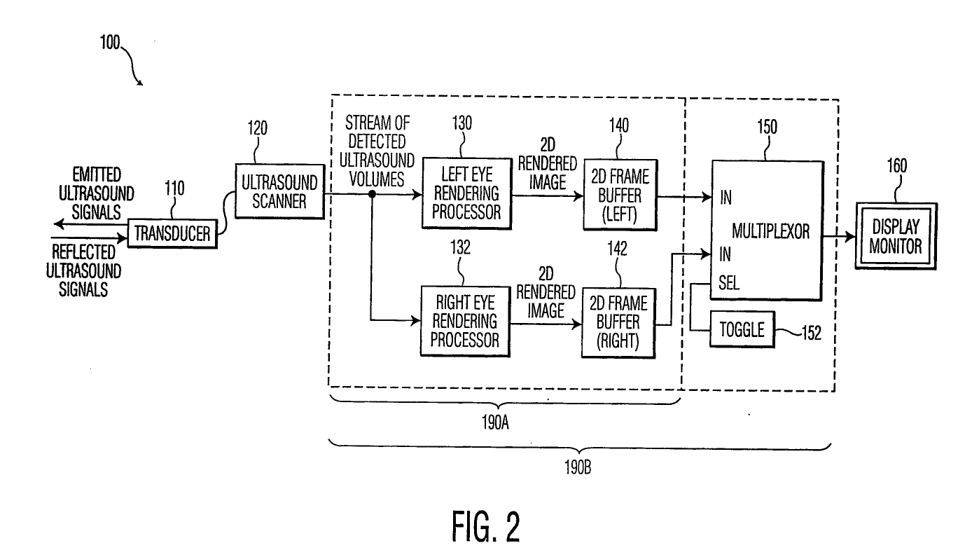

FIG. 2 is a block diagram of an ultrasound apparatus in accordance with the present invention;

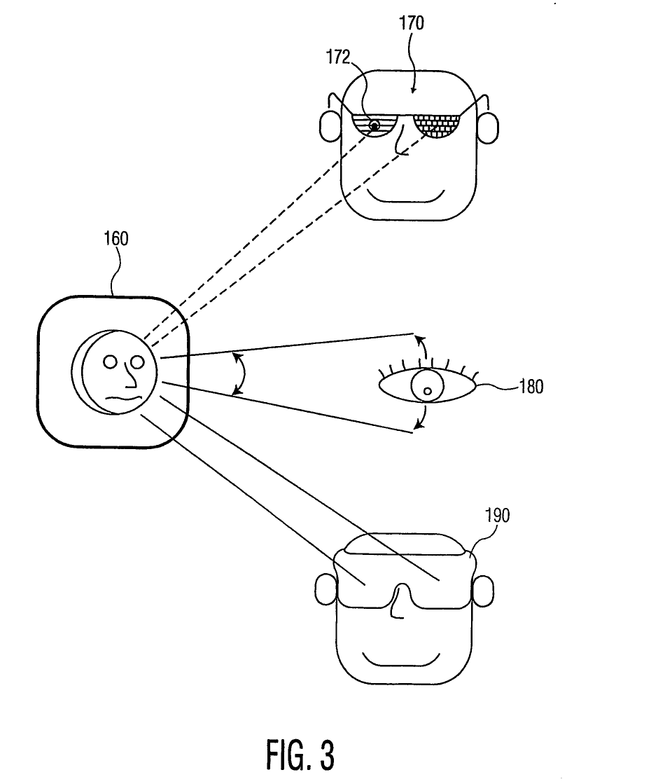

FIG. 3 is a diagram illustrating different methods of viewing the image displayed by the ultrasound apparatus of FIG. 2 to achieve a stereovision image;

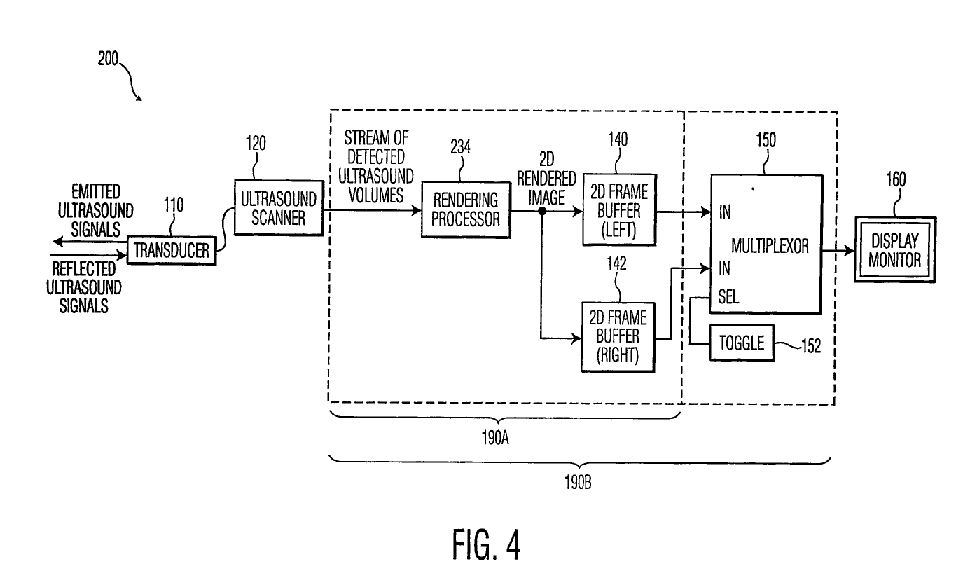

FIG. 4 is a block diagram of an ultrasound apparatus using a time-interleaved, or serial rendering.

Reference will now be made in detail to the present preferred embodiments of the present invention, examples of which are illustrated in the accompanying drawings. The embodiments are described below in order to explain the present invention by referring to the figures.

FIG. 2 is a block diagram of an ultrasound apparatus 100 in accordance with the present invention, which is similar in appearance to the conventional ultrasound machine 10 of FIG. 4. The ultrasound apparatus 100 includes a transducer 110 to emit a plurality of ultrasound signals to an object (not shown). The transducer 110 emits and receives ultrasound signals to create a volume dataset. The ultrasound signals are reflected by the object and received by the transducer 110.

The transducer 110 may be a two-dimensional phased array transducer. The two-dimensional phased array transducer includes a probe (not shown) including a plurality of elements to generate the emitted ultrasound signals. These elements are arranged in a two-dimensional array, for example, in a rectangular or circular shape. When generating an image of a fetus, it is sufficient to use a mechanical transducer, having a one-dimensional column of elements that is swept mechanically to interrogate a volume.

The transducer 110 then receives the reflected ultrasound signals and passes them on to an ultrasound scanner 120, which performs beamforming and generates a stream of detected 3D ultrasound volume datasets from the reflected ultrasound signals. The ultrasound scanner 120 may be of a basic “front end” type. The stream of detected ultrasound data volumes is then received by left and right eye rendering processors 130, 132 which simultaneously render the left eye angle and the right eye angle detected ultrasound data volumes to generate left and right 2D rendered images. The 2D rendered images are then received by left and right 2D frame buffers 140, 142, respectively, which hold the 2D rendered images as frames. A multiplexor 150 then toggles between frame buffers 140, 142, alternately selecting the left 2D rendered image and the right 2D rendered image and transmitting the selected image to a display monitor 160. This may be done at a rate of 120 Hertz, or 60 left images and 60 right images being displayed each second. A toggle 152 changes the rate at which the multiplexor 150 selects between the frame buffers 140, 142. A personal computer (PC) may be used as the rendering processors 130, 132 and the frame buffers 140, 142, as indicated by dotted box 190a. The PC may also include the multiplexor 150, as indicated by dotted box 190b. Display monitor 160 alternately displays the left 2D rendered image and the right 2D rendered image. The transducer 110, ultrasound scanner 120, rendering processors 130, 132, frame buffers 140, 142, multiplexor 150, and display monitor 160 are all housed on a single cart (not shown), which is similar to the cart 14 of FIG. 4.

FIG. 3 is a diagram illustrating different methods of viewing the image displayed by the display monitor 160 to achieve the stereovision image. The top portion of FIG. 3 illustrates a user wearing shuttered glasses 170. The shuttered glasses 170 include shutters 172, which alternately open and close on the left and right sides in synch with the display of the left and right 2D rendered images.

FIG. 3 further illustrates that the display monitor 160 may track a movement of the eye 180 of the user, to thereby generate the stereovision image. The present invention may also use recently developed monitors that do not need to track the eye movement. Finally, FIG. 3 illustrates that the user may wear a virtual reality headset 190. Thus, not only does the user view an image having true depth, but as the user changes his view, the image changes. For example, the user could be virtually positioned in the middle of the heart. If the user turns his head to the right, he would be looking at that section of the heart. Thus, the analysis of the heart or other object is facilitated by eliminating the need to manually select the view area.

FIG. 4 is a block diagram of an ultrasound apparatus 200 using a time-interleaved, or serial rendering. The ultrasound apparatus 200 of FIG. 4 is essentially the same as the ultrasound apparatus 100 of FIG. 2. However, a single rendering processor is provided 234 that alternately renders both the left eye angle and right eye angle detected ultrasound volumes, and alternately generates the left and right 2D rendered images to the frame buffers 140, 142, respectively. This differs from the parallel rendering performed by the rendering processors 130,132 of FIG. 1.

Unlike previous designs, the present invention is able to collect and process the large amount of data necessary to generate a stereovision image while still on the cart 14. Instead of processing the detected ultrasound volumes in batch mode, the rendering processors 130, 132, 234 render these volumes by streaming. Thus, the rendering is more continuous than in previous designs, resulting in a smoother image that can be more quickly adjusted. The rendering processors 130, 132, 234 may use any of several rendering algorithms to stream the ultrasound volumes. For example, the Shear-warp rendering algorithm published by Lacroute, P. & Levoy, M. [1994]. Fast volume rendering using a shear-warp factorization of the viewing transformation, Computer Graphics Proceedings, Annual Conference Series (SIGGRAPH '94), Orlando, pp. 451-458, may be used. Ray Casting, published by LeVoy, M. [1990]. Efficient ray tracing of volume data, ACM Transactions on Graphics 9(3): 245-261 is another algorithm that may be used.

The present invention eliminates the need for the time consuming process of downloading data and displaying the image at a remote location. Thus, errors in the sonography are detected immediately. Furthermore, a volume update rate in the order of 20-30 frames per second is possible. Thus, 20-30 new images are generated per second as opposed to the previous rate of one frame per second. Due to the improved display rate, when image parameters are adjusted, the updated image is displayed within a fraction of a second, as opposed to the previous 10-20 minute delay. The user perceives the feedback as contemporaneous with the adjustments because only a small fraction of a second is required to process the data Thus, unlike the previous designs, the present invention can provide a truly “real time” stereovision image on the cart 14.

With the present invention, the image can be updated at a rate of greater than or equal to 20 frames per second, and a latency of less than or equal to 100 milliseconds from the start of acquisition to display is achieved.

This image is smooth, life-like, and has true depth, and therefore improves over the previous choppy images which rely upon 2D representations of 3D objects. This feature is especially advantageous when displaying moving objects such as beating hearts or blood flow. Specifically, the present invention may be used in CFM (Color Flow Mode) displays, which display blood velocity in color mode rather than as a black and white part of the image. Other applications include Power Doppler, or “Angio,” in which the amplitude of the blood flow signal is displayed, and AQ (Acoustic Quantification). The present invention may also be used when displaying fetal images. In recent years, the demand for three-dimensional fetal photos has increased, as proud parents are more willing than ever to pay extra for a photo of their unborn “bundle of joy.”

Although a few preferred embodiments of the present invention have been shown and described, it would be appreciated by those skilled in the art that changes may be made in this embodiment without departing from the principles and spirit of the invention, the scope of which is defined in the claims and their equivalents.

1. A method of generating an image, comprising:
emitting ultrasound signals;
receiving reflected ultrasound signals;
converting the reflected ultrasound signals to a stereovision ultrasound image in real time; and
displaying the stereovision ultrasound image in real time.

2. The method of claim 1, wherein the converting of the reflected ultrasound signals comprises:
generating 3D ultrasound data volumes from the reflected ultrasound signals; and
rendering the 3D ultrasound data volumes into first and second 2D images by streaming,
the first and second 2D images comprising the stereovision ultrasound image.

3. The method of claim 2, further comprising adjusting the stereovision ultrasound image in real time.

4. The method of claim 3, further comprising updating the stereovision ultrasound image at a rate of greater than or equal to 10 frames per second.

5. An ultrasound apparatus, comprising:
an emitter to emit ultrasound signals;
a receiver to receive reflected ultrasound signals;
a signal processor to convert the reflected ultrasound signals to a stereovision ultrasound image in real time; and
a display unit to display the stereovision ultrasound image in real time.

6. The ultrasound apparatus of claim 5, wherein the signal processor comprises:
a generator to generate 3D ultrasound data volumes from the reflected ultrasound signals; and
a rendering processor to render the 3D ultrasound data volumes into first and second 2D images by streaming,
the first and second 2D images comprising the stereovision ultrasound image.

7. The ultrasound apparatus of claim 6, further comprising a transport unit to house said emitter, receiver, display unit, rendering processor and said generator.

8. The ultrasound apparatus of claim 7, wherein said transport unit is a cart.

9. The ultrasound apparatus of claim 7, wherein said display unit further comprises a control unit to control the stereovision ultrasound image in real time.

10. The ultrasound apparatus of claim 9, wherein the stereovision ultrasound image is updated at a rate of greater than or equal to 20 frames per second.

11. The ultrasound apparatus of claim 10, wherein the 3D ultrasound data volumes comprise first and second 3D data volumes, and said rendering processor renders the first and second 3D data volumes into the first and second 2D images, respectively.

12. The ultrasound apparatus of claim 11, further comprising a select unit to alternately transmit the first and second 2D images to said display unit to display the stereovision ultrasound image.

13. The ultrasound apparatus of claim 12, wherein a user views the stereovision ultrasound image through shuttered glasses.

14. The ultrasound apparatus of claim 12, wherein said display unit tracks an eye movement of a user to create the stereovision ultrasound image.

15. The ultrasound apparatus of claim 6, wherein said rendering processor continuously streams the 3D ultrasound data volumes.

16. The ultrasound apparatus of claim 12, wherein a user views the stereovision ultrasound image, and the stereovision ultrasound image changes corresponding to a movement of the user.

17. The ultrasound apparatus of claim 16, wherein the user views the stereovision ultrasound image through a virtual reality viewing unit connectible to the display unit to change the stereovision ultrasound image in accordance with the movement of the user.

18. The ultrasound apparatus of claim 12, wherein said rendering processor renders the first and second 3D data volumes in series.

19. The ultrasound apparatus of claim 12, wherein said rendering processor comprises left and right rendering processors to render the first and second 3D data volumes, respectively, in parallel.

20. The ultrasound apparatus of claim 12, wherein said select unit is a multiplexor.

21. The ultrasound apparatus of claim 5, wherein said emitter and said receiver comprise a two-dimensional phased array transducer.

22. An ultrasound apparatus, comprising:
an emitter to emit ultrasound signals;
a receiver to receive reflected ultrasound signals;
a signal processor to convert the reflected ultrasound signals to a stereovision ultrasound image in real time;
a display unit to display the stereovision ultrasound image; and
a transport unit to house said emitter, receiver, signal processor and said display unit.

23. The ultrasound apparatus of claim 22, wherein the signal processor comprises:
a generator to generate 3D ultrasound data volumes from the reflected ultrasound signals; and
a rendering processor to render the 3D ultrasound data volumes into first and second 2D images,
the first and second 2D images comprising the stereovision ultrasound image.

24. The ultrasound apparatus of claim 23, wherein said emitter and said receiver comprise a two-dimensional phased array transducer.

25. An ultrasound apparatus, comprising:
a transducer to emit ultrasound signals and to receive reflected ultrasound signals;
a scanner to generate a stream of detected ultrasound data volumes from the reflected ultrasound signals;
a rendering processor to render the stream of detected ultrasound data volumes into first and second 2D rendered images;
first and second buffers to hold the first and second 2D rendered images, respectively;
a display unit; and
a multiplexor to alternately transmit the first and second 2D rendered images to the display unit to generate a stereovision ultrasound image in real time.

26. The ultrasound apparatus of claim 25, further comprising a cart to house said transducer, scanner, rendering processor, first and second buffers, multiplexor and said display unit.

27. The ultrasound apparatus of claim 25, wherein said rendering processor renders the stream of detected ultrasound data volumes by streaming.

28. The ultrasound apparatus of claim 27, wherein the stereovision ultrasound image is a Color Flow Mode (CFM) image.

29. The ultrasound apparatus of claim 27, wherein the stereovision ultrasound image is a Power Doppler image.

30. The ultrasound apparatus of claim 27, wherein the stereovision ultrasound image is an Acoustic Quantification (AQ) image.

31. The method of claim 3, further comprising updating the stereovision ultrasound image at a latency of less than or equal to 200 milliseconds from start of acquisition to display.
